(19) United States
(12) Patent Application Publication
(10) Pub. No.: US 2015/0324819 A1
(43) Pub. Date: Nov. 12, 2015

(54) METHOD FOR PROVIDING PERSONALIZED ENERGY USE INFORMATION

(71) Applicant: Opower, Inc., Arlington, VA (US)

(72) Inventors: Wayne Lin, Washington, DC (US); Joanna Kochaniak, Needham, MA (US); Salman Suhail, Washington, DC (US); Carol Guest, Arlington, VA (US); Juliet Rothenberg, San Francisco, CA (US); Matt Betzel, Alexandria, VA (US); Eddy Leung, San Francisco, CA (US)

(21) Appl. No.: 14/543,132

(22) Filed: Nov. 17, 2014

Related U.S. Application Data
(63) Continuation-in-part of application No. 61/992,165, filed on May 12, 2014.

(51) Int. Cl. G06Q 30/02; G06Q 50/06

(52) U.S. Cl. CPC G06Q 30/0204; G06Q 50/06

(57) ABSTRACT

Techniques for providing personalized energy use information are described herein. An energy information system can obtain one or more of demographic, psychographic, behavioral, or consumption data for each of a plurality of utility customers, and segment the plurality of utility customers into a plurality of categories based on the demographic, psychographic, behavioral, or consumption data. The energy information system can select a target category from the plurality of categories based on a predetermined achievement goal and generate communications content based on historic energy consumption data for the target category. The energy information system can select an outbound communication channel for communicating with the target category. The energy information system can deliver one or more communications to the target category through the outbound communication channel at a specified time, where the one or more communications include at least a portion of the communications content.

### CROSS-REFERENCE TO RELATED APPLICATION

The present Application for Patent is a continuation in part of Application No. 61/992,165, filed May 12, 2014, entitled “ENERGY CAMPAIGN PLATFORM”, which is assigned to the assignee hereof, and is hereby expressly incorporated in its entirety by reference herein.

### BACKGROUND

1. Field

The subject technology relates to data processing systems, and more particularly to a method for providing personalized energy use information.

2. Background

Utility customers can significantly reduce expenses while improving their home's comfort level by adopting energy conserving practices. Substantial energy savings are possible with just behavioral changes without the need for home renovation or new appliances.

From product recommendations from online retailers, to financial advice from banks, to movie recommendations from media providers, companies are beginning to provide personalized content based on past behavior of customers. By providing the personalized content to the right customer at the right time in the right channel, the companies can increase the value of customer interactions and provide a superior customer experience.

### SUMMARY

The following presents a simplified summary of one or more implementations in order to provide a basic understanding of subject technology. This summary is not an extensive overview of all contemplated implementations of the present technology, and is intended to neither identify key or critical elements of all examples nor delineate the scope of any or all aspects of the present technology. Its sole purpose is to present some concepts of one or more examples in a simplified form as a prelude to the more detailed description that is presented later.

In accordance with one or more aspects of the examples described herein, systems and methods are provided for providing personalized energy use information.

In an aspect, a method is provided for providing personalized energy use information. The method includes obtaining one or more of demographic, psychographic, behavioral, or consumption data for each of a plurality of utility customers. The method includes segmenting the plurality of utility customers into a plurality of categories based on the demographic, psychographic, behavioral, or consumption data. The method includes selecting a target category from the plurality of categories based on a predetermined achievement goal. The method includes generating communications content based on historic energy consumption data for the target category. The method includes selecting an outbound communication channel for communicating with the target category. The method includes delivering one or more communications to the target category through the outbound communication channel at a specified time, where the one or more communications include at least a portion of the communications content.

In another aspect, an apparatus is provided for providing personalized energy use information. The apparatus includes at least one processor configured for segmenting a plurality of utility customers into a plurality of categories based on one or more demographic, psychographic, behavioral, or consumption data. The at least one processor is further configured for selecting a target category from the plurality of categories based on a predetermined achievement goal. The at least one processor is further configured for generating communications content based on historic energy consumption data for the target category. The at least one processor is further configured for selecting an outbound communication channel for communicating with the target category. The at least one processor is further configured for delivering one or more communications to the target category through the outbound communication channel at a specified time, where the one or more communications include at least a portion of the communications content.

In still another aspect, a non-transitory computer-readable medium is provided for providing personalized energy use information. The non-transitory computer-readable medium stores executable instructions which cause a data processing device to obtain one or more of demographic, psychographic, behavioral, or consumption data for each of a plurality of utility customers. The data processing device segments the plurality of utility customers into a plurality of categories based on the demographic, psychographic, behavioral, or consumption data. The data processing device generate communications content based on historic energy consumption data for a target category from the plurality of categories. The data processing device selects an outbound communication channel for communicating with the target category. The data processing device delivers one or more communications to the target category through the outbound communication channel at a specified time, where the one or more communications include at least a portion of the communications content.

### BRIEF DESCRIPTION OF THE DRAWINGS

In the following description, reference is made to the following figures, and in which are shown by way of illustration specific implementations in which the subject technology can be practiced. It is to be understood that other implementations can be utilized and changes can be made without departing from the scope of the subject technology.

FIG. 1 illustrates an example methodology for providing personalized energy use information;

FIG. 2 illustrates an example apparatus for providing personalized energy use information in accordance with the methodology of FIG. 1;

FIG. 3 illustrates an example of an energy information system for providing personalized energy use information, according to some aspects of the technology;

FIG. 4 illustrates an example of a conceptual segmentation scheme for a method of providing personalized use energy information;

FIG. 5 illustrates an example of communications content for a method of providing personalized energy use information;

FIGS. 6 and 7 illustrate examples of communications content for a method of providing personalized energy use information;

FIG. 8 illustrates an example relationship between willingness to take action and time;

FIG. 9 illustrates an example environment for providing personalized energy use information; and

FIG. 10 illustrates an example configuration of components of a data processing device, according to certain aspects of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and can be practiced without these details. In some instances, structures and components are shown in block diagram form in order to avoid obscuring the concepts of the subject technology.

Utility customers can significantly reduce expenses while improving their home's comfort level by adopting energy conserving practices. Substantial energy savings are possible with just behavioral changes without the need for home renovation or new appliances. However, due to the lack of provided energy saving data and education, most utility customers are not aware of their own energy consumption history and patterns, much less optimal methods to save energy given their situation.

By providing personalized content to the right customer at the right time in the right channel, companies can increase the value of customer interactions and provide a superior customer experience. However, delivering helpful content to the right customer at the right time through the right channel is challenging, especially in the utilities sector. Available services may not be able to gather sufficient relevant information for a large population of utility customers. In addition, the available services may not be able to effectively segment different customer categories and therefore may need to resort to a one-size-fits-all approach to delivering helpful content. The available services may not be specific enough to deliver personalized energy saving recommendations and take into account individualized behavior or household differences within the large population of utility customers. The available services may not be able manage the complexity of delivering personalized energy use information to customers with differing situations and needs. The available services may also not be able to analyze and determine which outbound channels and what specific times of content delivery is most effective for eliciting different customers to take action in reducing energy consumption.

Aspects of the subject technology allows for a means to encourage individuals to adopt more conservative energy consumption practices. In some aspects, the technology encourages people to increase efficiency by providing personalized energy use information. A method for providing the personalized energy use information can include obtaining one or more of demographic, psychographic, and/or behavioral data for each of a plurality of utility customers. The method includes segmenting the plurality of utility customers into a plurality of categories based on the demographic, psychographic, behavioral, or consumption data. The method can include generating communications content based on historic energy consumption data for the plurality of utility customers. The method can include selecting a target category from the plurality of categories based on a predetermined achievement goal. The method can include selecting an outbound communication channel for communicating with the target category. The method can include delivering one or more communications to the target category through the outbound communication channel at a specified time, where the one or more communications include at least a portion of the communications content.

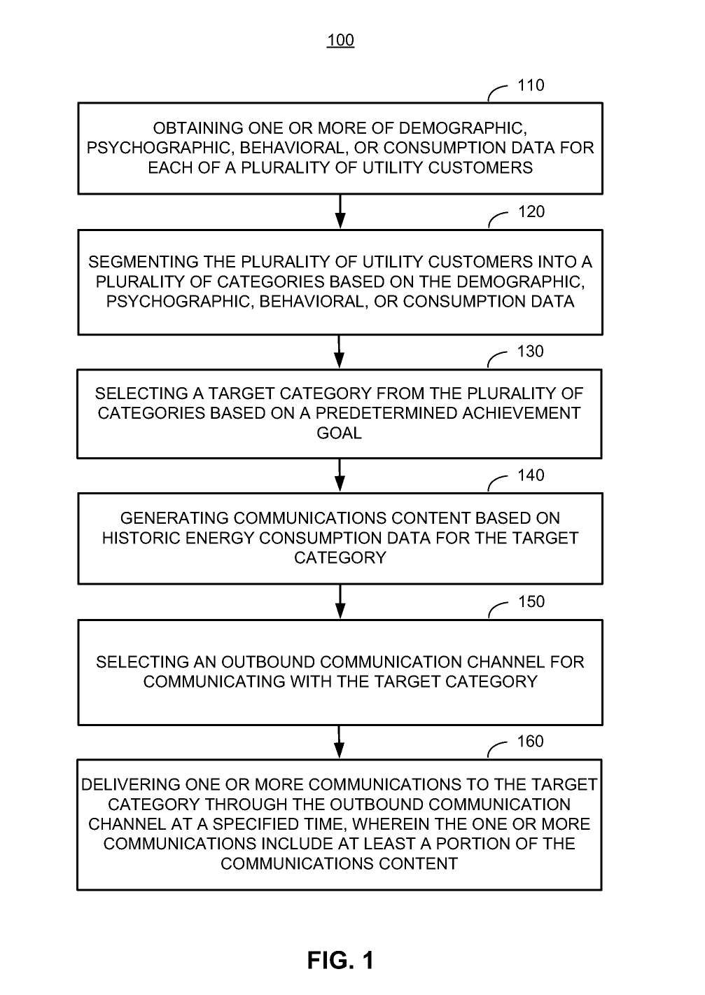

In accordance with one or more aspects of the implementations described herein, with reference to FIG. 1, a methodology 100 is shown for providing personalized energy use information. Method 100 can involve, at step 110, obtaining one or more of demographic, psychographic, behavioral, or consumption data for each of a plurality of utility customers. For example, the demographic data can include home ownership, location, age, gender, income, language ability, nationality, ethnicity, marital status, number of children, education level, occupation, or other such information. The psychographic data can include loyalty status, interests, lifestyle (e.g., resigned, struggler, mainstreamer, aspirer, succeeder, explorer, reformer, etc.), social class, or other such personality information. The consumption data can include monthly energy (e.g., water, electric, gas) spending and consumption data.

In a related aspect, the demographic, psychographic, behavioral, or consumption data can include customer provided data (e.g., user surveys or questionnaires) obtained from utility customers. For example, the customer provided data can be received directly from the utility customers via web pages, mobile applications, traditional mail, email, phone, or SMS. In another related aspect, the customer provided data can be obtained through an API vendor, an outbound vendor, a device vendor, a government census organization, a survey company, or another such party. Alternatively or additionally, customer provided data can be received via smart thermostats or other home installed devices.

In a related aspect, the demographic, psychographic, behavioral, or consumption data can include utility data, analytics insight, or other data. The utility data can be received from utility companies (e.g., gas, electric, and/or water suppliers, etc.). For example, a gas utility company can supply data on daily natural gas usage by gas customers in a particular geographic area. Alternatively or additionally, the utility data can be received from smart metering devices (e.g., smart thermostats). For example, the utility data received from smart thermostats can provide data on air conditioning and heating appliance power settings for various times during a day.

Method 100 can involve, at step 120, segmenting the plurality of utility customers into a plurality of categories based on the demographic, psychographic, and/or behavioral data. For example, segmentation can be based on home ownership status, home square footage, zip code, homeowner age, homeowner income, homeowner marital status, whether the homeowner has children, homeowner historic energy spending, homeowner energy usage compared to other similar homeowners, homeowner mobile phone ownership, homeowner internet access, whether the homeowner is enrolled in a particular program (e.g., a low income program, a smart thermostat program, a behavioral demand response program, or other utility program), or a combination of a number of different data points.

In a related aspect, the method can set thresholds for segmenting numerical type categories (e.g., home square footage, income, age, energy spending, number of children, etc.) For example, a threshold between “small homes” and “medium homes” categories may be determined as 1,500 square feet and another threshold between “younger homeowners” and “older homeowners” may be determined as 30 years old. The thresholds can be set manually by an administrator or automatically with a computerized algorithm. In a related aspect, a computerized algorithm can set one or more thresholds for a numerical type category by determining particular data points (e.g., square footage of a home) that correspond to large changes to another data point (e.g., monthly utility spending). In another related aspect, a computerized algorithm can set one or more thresholds for a numerical type category by evenly splitting a total number of the plurality of utility customers (e.g. splitting square footage into three categories with a substantially equal number of utility customers in each category).

Method 100 can involve, at step 130, selecting a target category from the plurality of categories based on a predetermined achievement goal. For example, the predetermined achievement goal can include causing a target category to take an energy saving action after an occurrence of a specific life event (e.g., moving in to a new home, receiving an unusually high utility bill, appliance shopping). In another example, the predetermined achievement goal can include driving participation in heating system upgrade programs. In still another example, the predetermined achievement goal can include reducing energy bills for homeowners younger than 30 years old or homeowners with an annual income under $30,000.

Method 100 can involve, at step 140, generating communications content based on historic energy consumption data for the target category. In a related aspect, the communications content can be curated content or custom content. The curated content can include premade campaigns stored in a library that target generalized (i.e., broader scope) achievement goals. For example, campaigns can include advertising or educational information that provide coaching to drive utility customers towards certain goals, such as energy efficiency, digital engagement, or cross-selling other services. Custom communications content can include campaigns that target specific (i.e., narrower scope) achievement goals.

In a related aspect, the method 100 can generate communications content based on historic energy consumption data for the target category of utility customers. For example, the content may include information about the energy usage of homeowners in the target category, advertisements, tips for the target category, recommendations, offers for the target category, or a combination of different information.

In a related aspect, the communications content can be curated content or custom content. The curated content can include premade campaigns stored in a library that target generalized (i.e., broader scope) achievement goals. Custom communications content can include campaigns that target specific (i.e., narrower scope) achievement goals.

In a related aspect, the communications content can correspond to one or more predetermined achievement goals. In another related aspect, the communications content can correspond to one or more categories of utility customers. For example, generating the communications content can be based on historic energy consumption data for at least one category of utility customers from the plurality of categories.

In a related aspect, generating the communications content can be based on historic energy consumption data for an individual utility customer. For example, the communications content can include personalized energy use insights, personalized energy saving recommendations, information about a homeowner's past energy usage, a homeowner's predicted energy usage, or a comparison of the homeowner's energy usage with other homeowners' energy usage (e.g., other homeowners in the same target category).

In a related aspect, the communications content can include event triggered content. The event triggered content can correspond to triggering events such as a move in, receiving a first bill, appliance shopping, receiving an unusually high bill, a utility service outage, or a lifestyle change. For example, a communications content including information on energy efficient appliances can correspond to the triggering event of appliance shopping. The method 100 can determine occurrence of the triggering events using the demographic, psychographic, behavioral, or consumption data obtained, for example, by receiving notifications from credit card reward programs or retailers of appliance purchases, energy consumption data from utility companies, notifications from utility companies of service outage complaints, notifications from utility companies of new accounts, notifications from utility companies of move requests or service terminations, customer provided data from utility customers, and/or other information sources.

Method 100 can involve, at step 150, selecting an outbound communication channel for communicating with the target category. For example the outbound communication channel can include at least one of via web pages, mobile applications, traditional mail, email, phone, short messaging service (SMS), or smart thermostats.

In a related aspect selecting the outbound communication channel can be based on a likelihood of customer engagement. For example, the likelihood of customer engagement can be determined by historical response rates to different outbound communication channels or by behavioral research for various demographic, psychographic, or behavior categories. The method 100 can collect user profiles for the plurality of utility customers that include age, income, home location, and consumption history to determine a likelihood of customer engagement. For example, the method 100 may select a mobile application outbound channel for utility customers younger than 30 years old who may have an increased likelihood of response when receiving communications content via a mobile application. Similarly, the method 100 may select an email outbound channel for utility customers with an income of greater than $100,000, who may have an increased likelihood of response when receiving communications content via email.

In another related aspect, selecting the outbound communication channel can be based on individual customer preferences. For example, a particular utility customer may have indicated via a SMS questionnaire of a preference for receiving communications content via traditional mail.

Method 100 can involve, at step 160, delivering one or more communications to the target category through the outbound communication channel at a specified time, wherein the one or more communications include at least a portion of the communications content.

In a related aspect, the specified time for delivering communications is based on a likelihood of customer engagement. For example, the specified time can be upon the triggering of certain events such as a move in, receiving a first bill, appliance shopping, receiving an unusually high bill, a utility service outage, or a lifestyle change. The occurrence of the triggering events can be determined using the demographic, psychographic, behavioral, or consumption data obtained, for example, by receiving notifications from credit card reward programs or retailers of appliance purchases, energy consumption data from utility companies, notifications from utility companies of service outage complaints, notifications from utility companies of new accounts, notifications from utility companies of move requests or service terminations, customer provided data from utility customers, and/or other information sources.

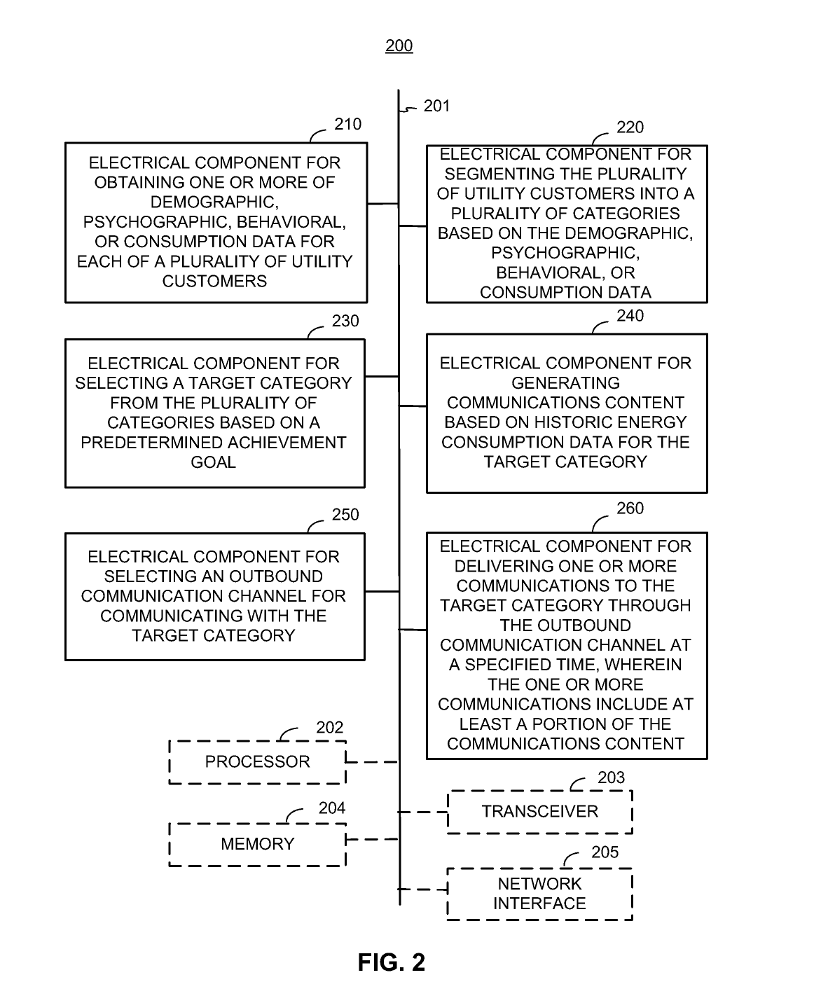

In accordance with one or more aspects of the implementations described herein, FIG. 2 illustrates an example apparatus 200 for providing personalized energy use information in accordance with the methodology of FIG. 1. Apparatus 200 can be configured as a data processing device or as a processor or similar device/component for use within. In one example, the apparatus 200 can include functional blocks that can represent functions implemented by a processor, software, or combination thereof (e.g., firmware). In another example, apparatus 200 can be a system on a chip (SoC), microprocessor or similar integrated circuit (IC).

In one implementation, apparatus 200 can include an electrical component or module 210 for obtaining one or more of demographic, psychographic, behavioral, or consumption data for each of a plurality of utility customers.

Apparatus 200 can include an electrical component 220 for segmenting the plurality of utility customers into a plurality of categories based on the demographic, psychographic, behavioral, or consumption data.

Apparatus 200 can include an electrical component 230 for selecting a target category from the plurality of categories based on a predetermined achievement goal.

Apparatus 200 can include an electrical component 240 for generating communications content based on historic energy consumption data for the target category.

Apparatus 200 can include an electrical component 250 for selecting an outbound communication channel for communicating with the target category.

Apparatus 200 can include an electrical component 260 for delivering one or more communications to the target category through the outbound communication channel at a specified time, wherein the one or more communications include at least a portion of the communications content.

In further related aspects, apparatus 200 can optionally include a processor component 202. The processor 202 can be in operative communication with the components 210-260 via a bus 201 or similar communication coupling. The processor 202 can effect initiation and scheduling of the processes or functions performed by electrical components 210-260.

In yet further related aspects, Apparatus 200 can include a radio transceiver component 203. A standalone receiver and/or standalone transmitter can be used in lieu of or in conjunction with the transceiver 203. Apparatus 200 can also include a network interface 205 for connecting to one or more other communication devices or the like. Apparatus 200 can optionally include a component for storing information, such as, for example, a memory device/component 204. The computer readable medium or the memory component 204 can be operatively coupled to the other components of apparatus 200 via the bus 201 or the like. The memory component 204 can be adapted to store computer readable instructions and data for affecting the processes and behavior of the components 210-260, and subcomponents thereof, or the processor 202, or the methods disclosed herein. The memory component 204 can retain instructions for executing functions associated with the components 210-260. While shown as being external to the memory 204, it is to be understood that the components 210-260 can exist within the memory 204. It is further noted that the components in FIG. 2 can include processors, electronic devices, hardware devices, electronic sub-components, logical circuits, memories, software codes, firmware codes, etc., or any combination thereof.

Persons skilled in the art will appreciate that the functionalities of each component of the apparatus 200 can be implemented in any suitable component of the system or combined in any suitable manner.

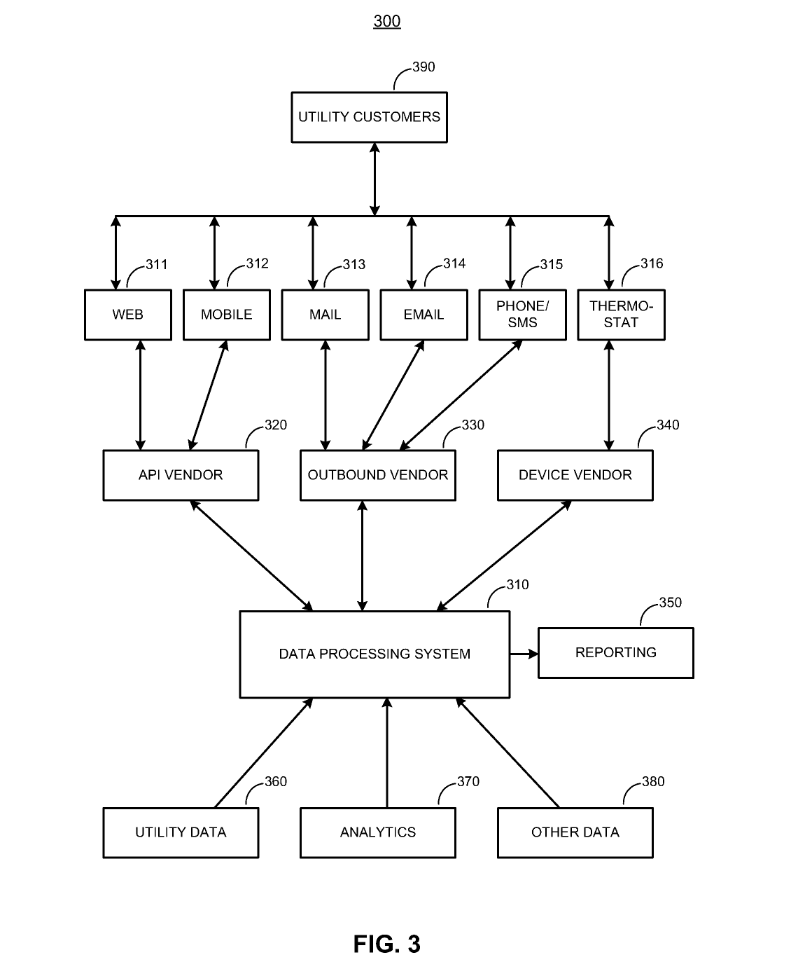

FIG. 3 illustrates an example energy information system 300 for providing personalized energy use information, according to some aspects of the technology. Energy information system 300 can include a data processing system 310. The data processing system 310 can include one or more data processing devices such as a computer server, each with one or more central processing units (CPUs). The data processing system 310 can be located in a centralized geographic location (e.g., in a single server or computer cluster), or can be distributed across a plurality of geographic locations, for example, using multiple computing devices that communicate via a network (not shown).

The data processing system 310 can receive demographic, psychographic, behavioral, or consumption data for each of a plurality of utility customers. In a related aspect, the demographic, psychographic, behavioral, or consumption data can include customer provided data (e.g., user surveys or questionnaires) from utility customers 390. For example, the customer provided data can be received directly from the utility customers 390 via web pages 311, mobile applications 312, traditional mail 313, email 314, or phone and SMS 315. In another example, the data processing system 310 can receive customer provided data through the API vendor 320, the outbound vendor 330, or the device vendor 340. Alternatively or additionally, data processing system 310 can automatically receive customer provided data via smart thermostats 316 or other home installed devices.

In a related aspect, the demographic, psychographic, behavioral, or consumption data can include utility data 350, analytics insight 370, or other data 380. The utility data 350 can be received from utility companies (e.g., gas, electric, and/or water suppliers, etc.). For example, a gas utility company can supply data on daily natural gas usage by gas customers in a particular geographic area. Alternatively or additionally, the utility data 360 can be received from smart metering devices (e.g., smart thermostats). For example, the utility data 360 received from smart thermostats can provide data on air conditioning and heating appliance power settings for various times during a day.

The analytics insight 370 can be received from one or more storage units and/or a database that is configured to store and provide patterns pertaining to utility consumption data. For example, a pattern of utility consumption may show that homeowners younger than 30 years old have higher energy consumption between 9 pm and 12 am compared to older homeowners. Alternatively, in some embodiments such patterns are provided by a third party service, such as an analytics vendor.

In a related aspect, the other data 380 can include demographic data, psychographic data, behavioral data, historic resource usage data, weather data (e.g., past weather history, current weather readings, and/or weather forecasts received from a third-party weather service), and/or temperature data that can be relevant to energy consumption patterns of one or more utility customers.

In a related aspect, the data processing system 310 can communicate personalized energy use information to utility customers 390 either directly or indirectly via at least one outbound communication channel. For example, the outbound communication channel can include at least one of via web pages 311, mobile applications 312, traditional mail 313, email 314, phone 315, SMS 315, smart thermostats 316, or other communication channel. In another example, the outbound communication channel includes at least one of API vendor 320, outbound vendor 330, or device vendor 340.

In some implementations, the energy use information can be indirectly communicated through third party vendors that can include an application programming interface (API) vendor 320, an outbound vendor 330, and/or a device vendor 340. It is understood that any one or more of API vendor 320, the outbound vendor 330, and/or the device vendor 340 can be third parties that provide various communication services to the utility customers via various communication channels.

In a related aspect, the API vendor 320 can communicate personalized energy use information with utility customers 390 via web pages 311 or mobile applications 312. By way of example, personalized messages or communications can be provided, for example, via a portal of an energy-use management account, or delivered as a notification, e.g., via a mobile application (e.g. mobile application 312) running on a device associated with the targeted user.

In a related aspect, the outbound vendor 330 can communicate personalized energy use information with the utility customers 390 via at least one of traditional mail 313, email 314, phone (e.g., interactive voice response (IVR)) 315, short messaging service (SMS), multimedia messaging service (MMS), or other communication service.

In some implementations, the device vendor 340 can communicate personalized energy use information with the utility customers 390 e.g., via one or more smart thermostats 316 or other smart appliance located in the utility customer's home and/or business.

In some implementations, the data processing system 310 can bypass the API vendor 320, the outbound vendor 330, and/or the device vendor 340 to reach the utility customers 390 directly via at least one of web pages 311, mobile applications 312, traditional mail 313, email 314, phone 315, SMS 315, smart thermostats 316, or other communication channel.

In a related aspect, the data processing system 310 can report 350 utility data to third parties such as, for example, utility companies, government organizations, research institutions, consumers, and/or advertisers. For example, the utility data can be sent to the third parties via a continuous data feed or regular reports. In another example, the third parities can use a web interface to gain access to the reports. In yet another example, the utility data can be reported to the third parties in via the same or similar outbound channels used to deliver utility data to the utility customers 390.

In a related aspect, selecting the outbound communication channel can be based on a likelihood of customer engagement. For example, the data processing system can use a user profile for a utility customer that includes age, income, home location, and consumption history to determine a likelihood of customer engagement. The data processing system 310 may select the mobile application outbound channel 312 for utility customers younger than 30 years old who may have an increased likelihood of response when receiving communications content via a mobile application. Similarly, the data processing system 310 may select the email outbound channel 313 for utility customers with an income of greater than $100,000, who may have an increased likelihood of response when receiving communications content via email.

In another related aspect, selecting the outbound communication channel can be based on individual customer preferences. For example, a particular utility customer may have indicated via a SMS questionnaire of a preference for receiving communications content via traditional mail 313. The data processing system 310 can then select the outbound communication channel by using the particular utility customer's indicated preference.

In still another related aspect, the specified time for delivering communications is based on a likelihood of customer engagement. For example, the specified time can be predefined by an administrator or can be determined automatically by the data processing system 310. The specified time can be determined to maximize the likelihood of customer engagement in response to the communications delivered. For example, delivering communications upon triggering events such as a move in, receiving a first bill, appliance shopping, receiving an unusually high bill, a utility service outage, or a lifestyle change, can provide a statistically higher likelihood of customer engagement. The data processing system 310 can determine occurrence of the triggering events using the demographic, psychographic, behavioral, or consumption data obtained, for example, by receiving notifications from credit card reward programs or retailers of appliance purchases, energy consumption data from utility companies, notifications from utility companies of service outage complaints, notifications from utility companies of new accounts, notifications from utility companies of move requests or service terminations, customer provided data from utility customers, and/or other information sources.

The energy information system 300 can select a target category of utility customers from the plurality of categories can be based on accomplishing a predetermined achievement goal. For example, the predetermined achievement goal can include causing a target category to take an energy saving action after an occurrence of specific life events (e.g., moving in to a new home, receiving an unusually high utility bill, appliance shopping). In another example, the predetermined achievement goal can include driving participation in heating system upgrade programs. In still another example, the predetermined achievement goal can include reducing energy bills for home owners younger than 30 years old or homeowners with an annual income under $30,000.

The energy information system 300 can generate communications content based on historic energy consumption data for the target category of utility customers. For example, the content may include information about the energy usage of homeowners in the target category, advertisements, tips for the target category, recommendations, offers for the target category, or a combination of different information.

In a related aspect, the communications content can be curated content or custom content. The curated content can include premade campaigns stored in a library that target generalized (i.e., broader scope) achievement goals. Custom communications content can include campaigns that target specific (i.e., narrower scope) achievement goals.

In a related aspect, the communications content can correspond to one or more predetermined achievement goals. In another related aspect, the communications content can correspond to one or more categories of utility customers. For example, generating the communications content can be based on historic energy consumption data for at least one category of utility customers from the plurality of categories.

In a related aspect, generating the communications content can be based on historic energy consumption data for an individual utility customer. For example, the communications content can include personalized energy use insights, personalized energy saving recommendations, information about a homeowner's past energy usage, a homeowner's predicted energy usage, or a comparison of the homeowner's energy usage with other homeowners' energy usage (e.g., other homeowners in the same target category).

In a related aspect, the communications content can include event triggered content. The event triggered content can correspond to triggering events such as a move in, receiving a first bill, appliance shopping, receiving an unusually high bill, a utility service outage, or a lifestyle change. For example, a communications content including information on energy efficient appliances can correspond to the triggering event of appliance shopping. The data processing system 310 can determine occurrence of the triggering events using the demographic, psychographic, behavioral, or consumption data obtained, for example, by receiving notifications from credit card reward programs or retailers of appliance purchases, energy consumption data from utility companies, notifications from utility companies of service outage complaints, notifications from utility companies of new accounts, notifications from utility companies of move requests or service terminations, customer provided data from utility customers, and/or other information sources.

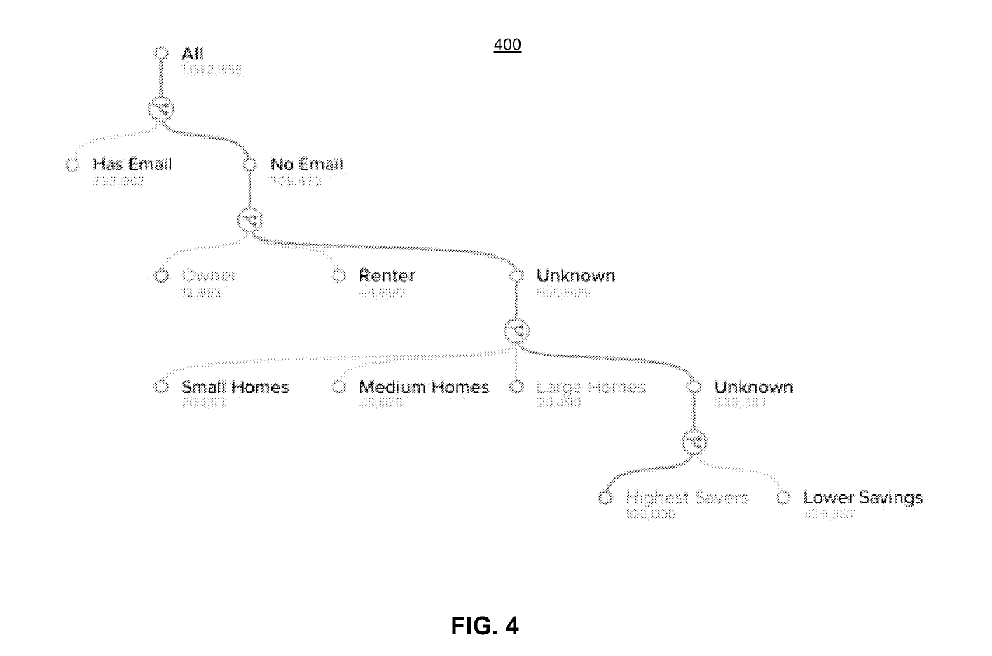

FIG. 4 illustrates an example conceptual scheme of segmentation 400 for a method of providing personalized energy use information. In the example illustrated by segmentation scheme 400 a total of 1,042,355 utility customers, categorized under the “All” category. The “All” category can be segmented into 333,903 utility customers that use email under the “Has Email” category and 708,452 utility customers that do not use email under the “No Email” category. The “No Email” category can be further segmented based on home ownership status; that is, into 12,953 utility customers that own their homes under the “Owner” category, 44,890 utility customers that rent their homes under the “Renter” category, and 650,609 utility customers for whom the energy information system 300 (FIG. 3) does not have home status information under the “Unknown Own or Rent” category.

In turn, the “Unknown Own or Rent” category can be further segmented based on known information pertaining to home size, that is, into 20,853 utility customers that live in small size homes under “Small Homes,” 69,879 utility customers that live in medium sized homes under “Medium Homes,” 20,490 utility customers that live in large sized homes under “Large Homes,” and 539,387 utility customers for whom the energy information system 300 does not home size information under “Unknown Home Size.” The “Unknown Home Size” category can be further segmented into 100,000 utility customers that are established energy savers under “Highest Savers” and 439,387 utility customers that are not established energy savers under “Lower Savings.”

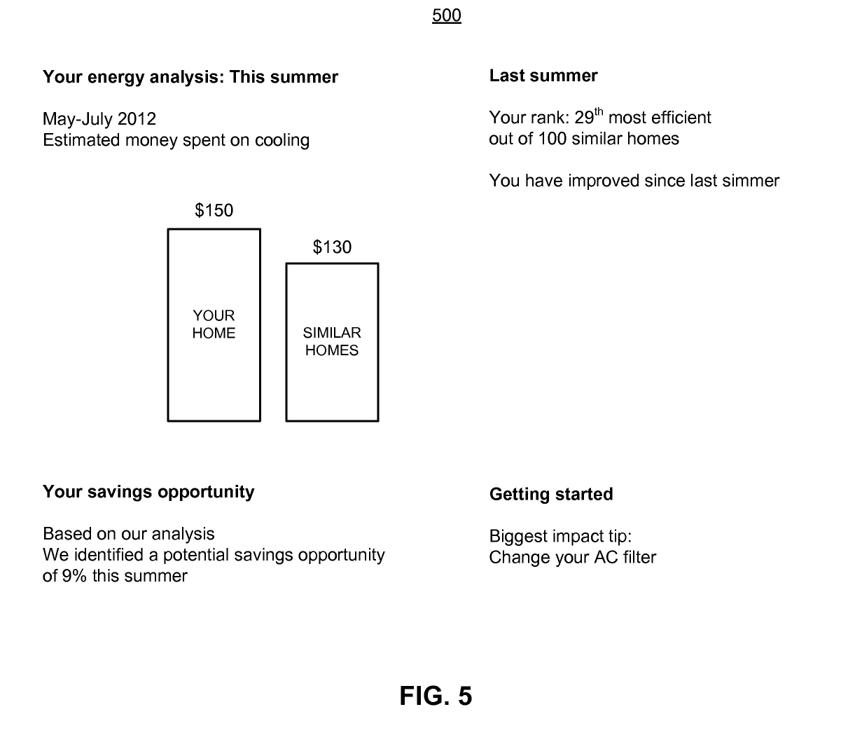

FIG. 5 illustrates an example of communications content 500 that can be used for providing personalized energy use information. The communications content 500 can include personalized information based on an individual utility customer's energy spending and on energy spending for one or more categories of utility customers. It is understood that other types of information content can be provided and other content arrangements can be used in the delivery.

In the illustrated example, of FIG. 5, communications content 500 indicates that the individual utility customer's energy spending on cooling (e.g., air conditioning costs) in a current summer season is $150 while an average energy spending on cooling is $130 for similar utility customers. In a related aspect, similar utility customers can be defined by one or more segmented categories. The personalized information can be displayed using a graph or chart in addition or alternatively to text. The communications content 500 can indicate a ranking for the individual utility customer's energy spending compared to the similar utility customers is twenty-ninth out of one hundred. The communications content 500 may further indicate whether the ranking has improved or gotten worse as compared to another time period (e.g., last year's summer season). The communications content 500 can indicate one or more specific methods for the individual utility customer to save on energy spending, such as for example changing an air-conditioning filter to save up to eight percent on energy spending.

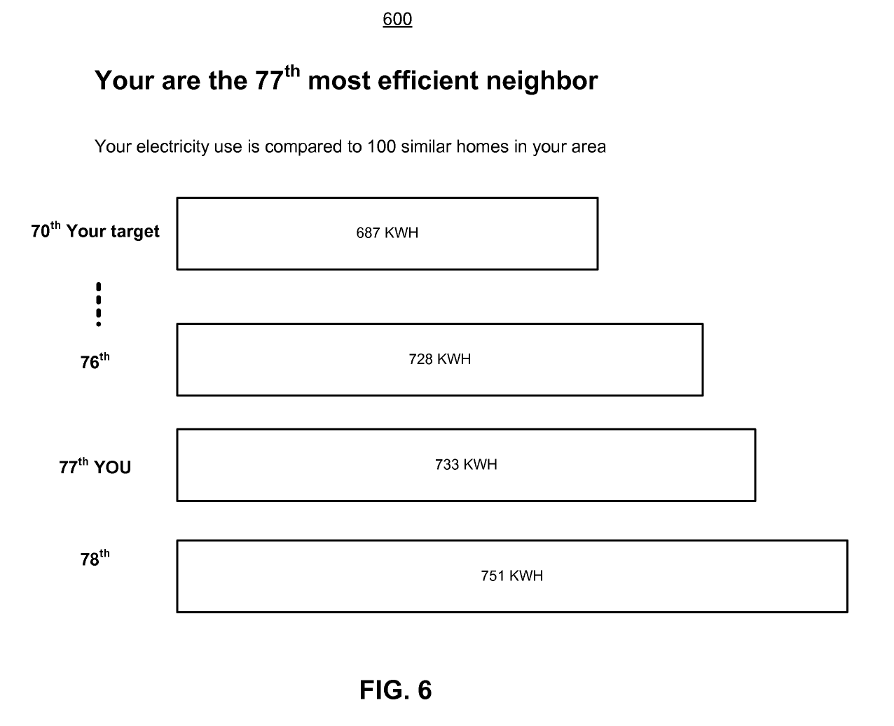

FIG. 6 illustrates an example of communications content 600 that can be used for providing personalized energy use information, according to some aspects of the technology. The communications content 600 can include personalized information based on an individual utility customer's energy efficiency and on energy efficiency for one or more categories of utility customers. For example, the communications content 600 can indicate that the individual utility customer's energy efficiency is ranked seventy-seventh amongst one hundred neighboring utility customers. The personalized information can be displayed using a graph or chart in addition or alternatively to text.

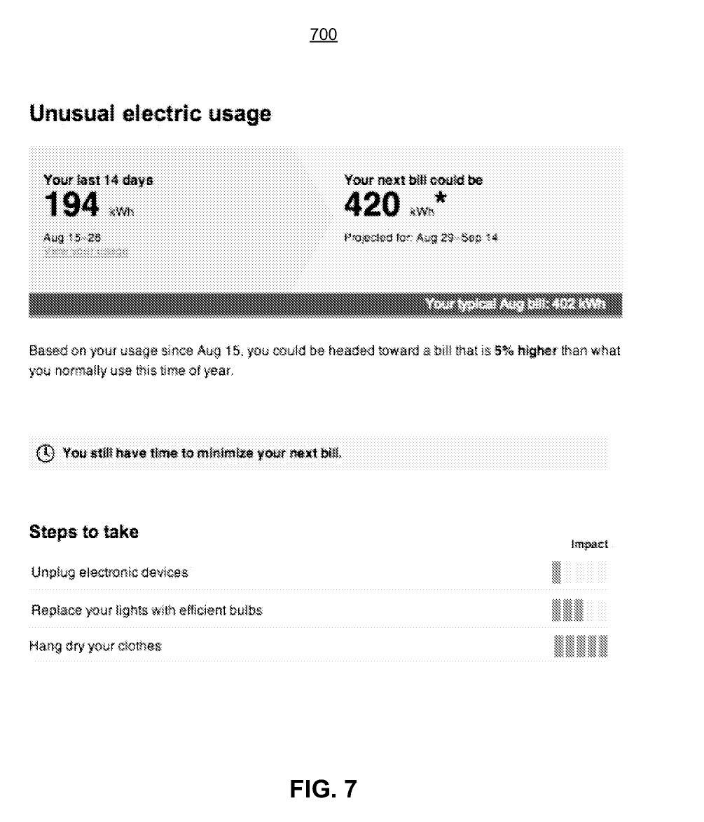

FIG. 7 illustrates another example of communications content used for providing personalized energy use information, according to some aspects of the technology. The communications content 700 can include personalized information based on an individual utility customer's energy consumption over a certain period of time. For example, the communications content 700 can indicate that the individual utility customer's energy consumption in the last fourteen days is one-hundred ninety-four kilowatt hours (kWh). The communications content 700 can indicate a projected energy consumption of four-hundred twenty kWh for the current month based on historic energy consumption data for the individual utility customer. The communications content 700 can indicate one or more specific steps for the individual utility customer to save on energy consumption, such as for example unplugging electronic devices, replacing light bulbs with energy efficient bulbs, or hang drying clothing.

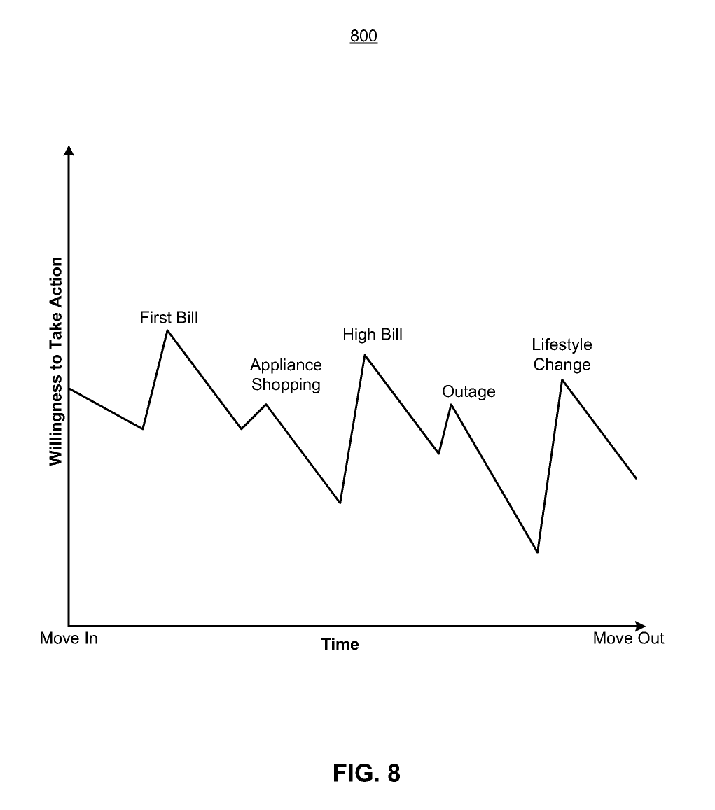

FIG. 8 illustrates an example relationship between willingness to take action (or likelihood of customer engagement) and time for various life events. The relationship can be determined by historical data or predictive analysis for either a specific individual utility customer or for one or more segmented categories of utility customers. For example, a utility customer may have an increased willingness to take action (i.e., proactive steps to save energy) after triggering events. For example, the triggering events can include a move in, receiving a first bill, appliance shopping, receiving an unusually high bill, a utility service outage, or a lifestyle change. In a related aspect, the energy information system 300 can use the relationship to generate triggering events or event triggered content.

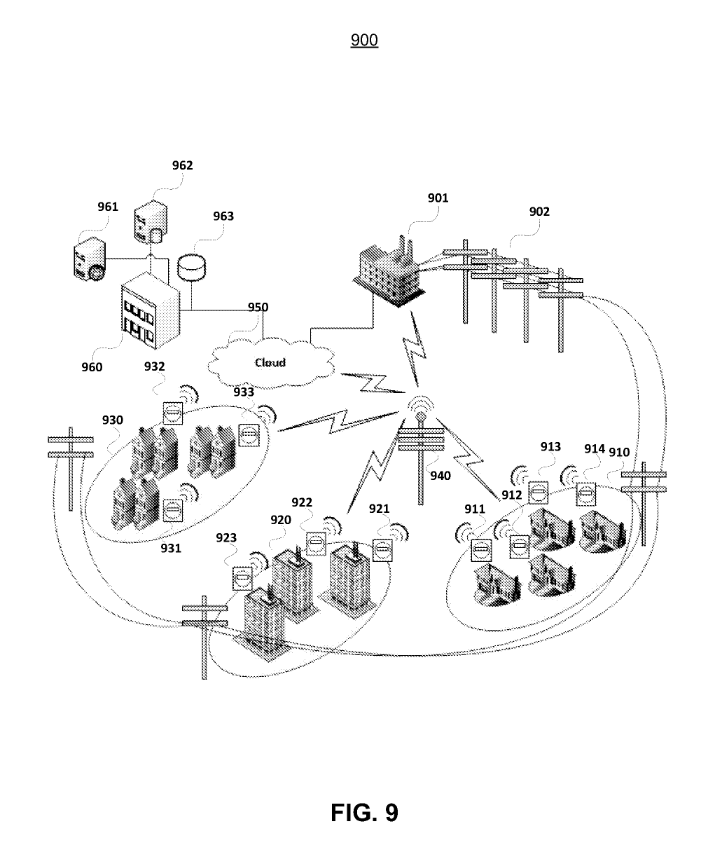

FIG. 9 illustrates an example environment 900 for providing personalized energy use information. The environment 900 can include a utility company 901, a power distribution system 902, utility customer regions 910, 920, and 930, an energy consumption collector 940, a network 950 (e.g., a cloud network), and an energy information system 960. The utility customer region 910 can include residential structures with corresponding smart meters 911-914. The utility customer region 920 can include commercial structures with corresponding smart meters 921-923. The utility customer region 930 can include multi-family structures with corresponding smart meters 931-933. The energy information system 960 can include a web server 961, an application server 962, and a database 963.

The utility company 901 can provide a commodity (e.g., electricity, gas, water) to the utility customer regions 910, 920, and 930. The utility company 901 can track the energy consumption from each region via a monitoring device (e.g., a smart meter) associated with each structure of the corresponding region. The utility company 901 can receive consumption data that includes the amount of energy consumption (e.g., kWh) for the corresponding utility account. In an aspect, the utility company 901 can receive the consumption data from the energy consumption collector 940 via a wireless communication system. In a related aspect, the energy consumption collector 940 can obtain the consumption data by receiving the consumption data from each of the smart meter devices. The smart meter devices can broadcast consumption data on a periodic or scheduled basis. The utility company 901 also can receive the consumption data from each monitoring device through a wired communication system.

The energy information system 960 can be in communication with the utility company 901 via the network 950. The energy information system 960 can obtain the consumption data from the utility company 901 via the network 950. In an aspect, the energy information system 960 can receive the consumption data via the network 950. The energy information system 960 can receive the consumption data directly from the smart meter devices.

Each of the utility customer regions 910, 920, and 930 can correspond to a separate geographical location with a respective rate schedule. In a related aspect, a communications content for a corresponding utility customer in one region can be generated using consumption data of similar users in the same region to provide the corresponding utility customer with a comparative analysis of its energy consumption (e.g., current energy consumption compared to similar customers in the same zip code or within a certain radius).

The energy information system 960 can be in communication with a third party weather service, such as the National Weather Service (not shown). For example, the energy information system 960 can receive corresponding outdoor temperatures from the third party weather service via the network 950 (e.g., e-mails, downloaded FTP files, and XML feeds). In this respect, the energy information system 960 can use data from the third party weather service to determine a projected use for a current billing period. For example, forecasted weather conditions (e.g., the temperature, the humidity, the barometric pressure, precipitation, etc.) can indicate that the utility customer's HVAC system is likely to be in greater use. The energy information system 960 can estimate the projected use for the remaining amount of time of a current billing period, and thereby determine if the utility customer is on pace to exceed a projected bill based on the estimated projected use. In this respect, the energy information system 960 can generate one or more energy conservation recommendations. In turn, the energy information system 960 can notify the utility customer through the communications content.

The energy information system 960 can deliver the communications content to utility customers associated with the utility customer regions 910, 920, and 930. In some aspects, the energy information system 960 communicates the communications content via the network 950. For example, the energy information system 960 can send the communications content in an e-mail or the utility customer can log into the energy information system 960 (e.g., the web server 961 and/or application server 962) through a website to view the desegregated consumption data included in the energy consumption alert notification. In a related aspect, the energy consumption information including billing information is communicated back to the utility company 901 such that the utility company 901 can provide the communications content to the utility customer.

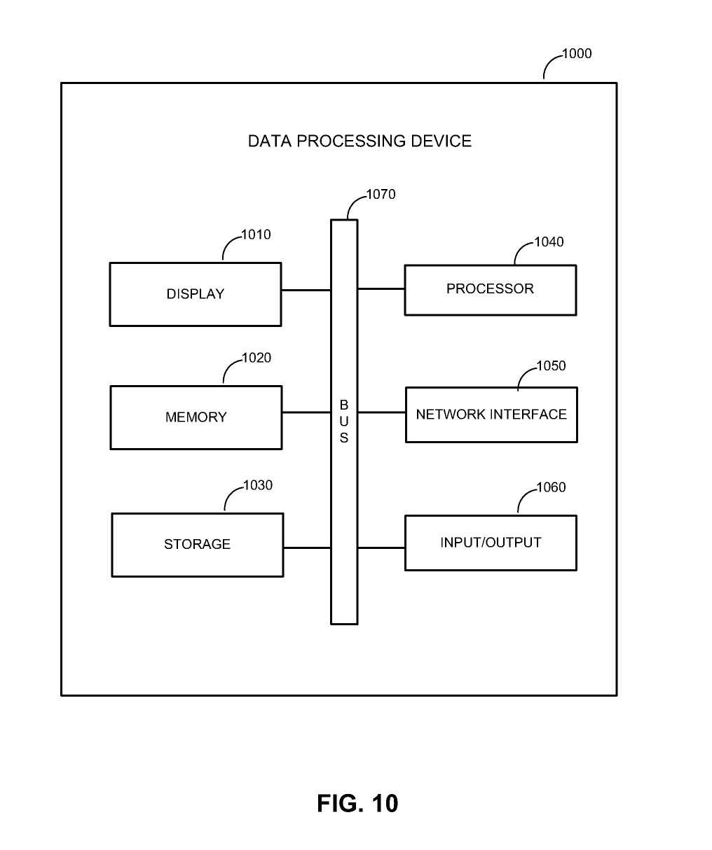

FIG. 10 illustrates an example configuration of components of a data processing device (e.g., the energy information system 960 of FIG. 9), according to certain aspects of the subject technology. As would be apparent to one of ordinary skill in the art, the data processing device 1000 can include a display 1010, a memory 1020, a non-transitory computer-readable storage 1030, a processor 1040, a network interface 1050, an input/output component 1060, and a bus 1070.

The data processing device 1000 can be, for example, a server (e.g., one of many rack servers in a data center) or a personal computer. The processor (e.g., central processing unit) 1040 can retrieve and execute programming instructions stored in the memory 1020 (e.g., random-access memory). The programming instructions can cause the data processing device 1000 to execute the methodology 100 for providing personalized energy use information, as shown in FIG. 1. The processor 1040 can be a single CPU with a single processing core, a single CPU with multiple processing cores, or multiple CPUs. The bus 1070 can transmit instructions and application data between device components such as the processor 1040, the memory 1020, the storage 1030, and the networking interface 1050.

The display 1010 can include a touch screen or liquid crystal display (LCD). The storage 1030 can include any form of non-volatile form of data storage such as a hard disk drive (HDD) or a flash drive. The input/output component 1060 can receive input from a user. This input/output component can include, for example, a push button, touch pad, touch screen, wheel, joystick, keyboard, mouse, keypad, or any other such device or element whereby a user can input a command to the device. In a related aspect, such a device might not include any buttons at all, and might be controlled through a combination of visual and audio commands, such that a user can control the device without having to be in physical contact with the device.

The network interface 1050 can include a Wi-Fi, Bluetooth®, radio frequency, near-field communication, wired, or wireless communication system. The data processing device 1000 in many implementations can communicate with a network, such as the Internet, and can be able to communicate with other such devices.

The various implementations can be implemented in a wide variety of operating environments, which in some cases can include one or more user computers, data processing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as can be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most implementations utilize at least one network that would be familiar to those skilled in the art for supporting communications using any of a variety of commercially-available protocols, such as TCP/IP, OSI, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In implementations utilizing a Web server, the Web server can run any of a variety of server or mid-tier applications, including HTTP servers, FTP servers, CGI servers, data servers, Java servers, and business map servers. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, or TCL, as well as combinations thereof. The server(s) can also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of implementations, the information can reside in a storage-area network (“SAN”) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system can also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate implementations can have numerous variations from that described above. For example, customized hardware might also be used and/or particular elements might be implemented in hardware, software (including portable software, such as applets), or both. Further, connection to other data processing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various implementations.

The specification and drawings are, accordingly, to be regarded in an illustrative rather than a restrictive sense. It will, however, be evident that various modifications and changes can be made thereunto without departing from the broader spirit and scope of the disclosure as set forth in the claims.

The description of the subject technology is provided to enable any person skilled in the art to practice the various implementations described herein. While the subject technology has been particularly described with reference to the various figures and implementations, it should be understood that these are for illustration purposes only and should not be taken as limiting the scope of the subject technology.

There can be many other ways to implement the subject technology. Various functions and elements described herein can be partitioned differently from those shown without departing from the scope of the subject technology. Various modifications to these implementations will be readily apparent to those skilled in the art, and generic principles defined herein can be applied to other implementations. Thus, many changes and modifications can be made to the subject technology, by one having ordinary skill in the art, without departing from the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

1. A computer-implemented method for providing personalized energy use information, comprising:
obtaining one or more of demographic, psychographic, behavioral, or consumption data for each of a plurality of utility customers;
segmenting the plurality of utility customers into a plurality of categories based on the demographic, psychographic, behavioral, or consumption data;
selecting a target category from the plurality of categories based on a predetermined achievement goal;
generating communications content based on historic energy consumption data for the target category;
selecting an outbound communication channel for communicating with the target category; and
delivering one or more communications to the target category through the outbound communication channel at a specified time, wherein the one or more communications include at least a portion of the communications content.

2. The method of claim 1, wherein the one or more of demographic, psychographic, behavioral, or consumption data includes customer provided data from web pages, mobile applications, traditional mail, email, phone, or SMS.

3. The method of claim 1, wherein the one or more of demographic, psychographic, behavioral, or consumption data includes utility data received from at least one utility company.

4. The method of claim 1, wherein the predetermined achievement goal can include causing the target category to take an energy saving action after an occurrence of a specific life event.

5. The method of claim 1, wherein the communications content corresponds to a triggering event such as a move in, receiving a first bill, appliance shopping, receiving an unusually high bill, a utility service outage, or a lifestyle change.

6. The method of claim 1, wherein generating the communications content is based on historic energy consumption data for at least one category of utility customers from the plurality of categories.

7. The method of claim 1, wherein generating the communications content is based on historic energy consumption data for an individual utility customer.

8. The method of claim 1, wherein the communications content further includes personalized energy use insights or personalized energy saving recommendations.

9. The method of claim 1, wherein the outbound communication channel is via at least one of web page, mobile application, traditional mail, email, phone, short messaging service (SMS), or smart thermostat.

10. The method of claim 1, wherein the outbound communication channel is via at least one of an application programming interface (API) vendor, an outbound vendor, or a device vendor.

11. The method of claim 1, wherein selecting the outbound communication channel is based on a likelihood of customer engagement.

12. The method of claim 1, wherein selecting the outbound communication channel is based on individual customer preferences.

13. The method of claim 1, wherein the specified time is based on a likelihood of customer engagement.

14. The method of claim 1, wherein the specified time is based on at least one of a home moving date, reception of a high utility bill, or participation of a home utility program.

15. An apparatus configured for providing personalized energy use information, the apparatus comprising at least one processor configured for:
segmenting a plurality of utility customers into a plurality of categories based on one or more demographic, psychographic, behavioral, or consumption data;
selecting a target category from the plurality of categories based on a predetermined achievement goal;
generating communications content based on historic energy consumption data for the target category;
selecting an outbound communication channel for communicating with the target category; and
delivering one or more communications to the target category through the outbound communication channel at a specified time, wherein the one or more communications include at least a portion of the communications content.

16. The apparatus of claim 15, further comprising obtaining the one or more of demographic, psychographic, behavioral, or consumption data for each of the plurality of utility customers by receiving customer provided data from the plurality of utility customers and/or utility data from at least one utility company.

17. The apparatus of claim 15, wherein selecting the outbound communication channel is based on a likelihood of customer engagement.

18. A non-transitory computer-readable medium storing executable instructions which cause a data processing device to:
obtain one or more of demographic, psychographic, behavioral, or consumption data for each of a plurality of utility customers;
segment the plurality of utility customers into a plurality of categories based on the demographic, psychographic, behavioral, or consumption data;
generate communications content based on historic energy consumption data for a target category from the plurality of categories;
select an outbound communication channel for communicating with the target category; and
deliver one or more communications to the target category through the outbound communication channel at a specified time, wherein the one or more communications include at least a portion of the communications content.

19. The non-transitory computer-readable medium of claim 18, wherein the computer-readable medium further causes the data processing device to select the target category from the plurality of categories based on a predetermined achievement goal.

20. The non-transitory computer-readable medium of claim 18, wherein the specified time is based on a likelihood of customer engagement.
